(19) United States
(12) Patent Application Publication
(10) Pub. No.: US 2026/0264384 A1
(43) Pub. Date: Sep. 10, 2026

(54) SCREEN PROTECTOR APPLICATOR

(71) Applicant: Yunlin Xu, Shenzhen (CN)

(72) Inventor: Dingjun Liu, Shenzhen (CN)

(21) Appl. No.: 19/658,937

(22) Filed: Apr. 27, 2026

(30) Foreign Application Priority Data
Feb. 9, 2026 (CN) 202620195560.5
Feb. 9, 2026 (CN) 202620195570.9

(51) Int. Cl. B32B 37/00; B32B 37/10

(52) U.S. Cl. CPC B32B 37/0046; B32B 37/10; B32B 2037/109; B32B 2457/20

(57) ABSTRACT

A screen protector applicator includes a support assembly configured to support a mobile terminal and a screen protector assembly; and a squeegeeing assembly, configured to be arranged on a side of the screen protector assembly facing away from the mobile terminal and is movably connected to the support assembly. The squeegeeing assembly includes a flexible squeegeeing element configured to apply a pressure onto the screen protector assembly during movement of the squeegeeing assembly relative to the screen protector assembly, so as to attach the screen protector onto the mobile terminal.

### CROSS-REFERENCE TO RELATED APPLICATIONS

This application claims priority of Chinese patent application CN202620195560.5, filed on Feb. 9, 2026, and Chinese patent application CN 202620195570.9, filed on Feb. 9, 2026, the entire contents of which are incorporated herein by reference.

### TECHNICAL FIELD

The present disclosure relates to screen protector application technologies, and in particular, to a screen protector applicator.

### BACKGROUND

Generally, in order to protect a display screen or an outer surface of a mobile terminal, a user can use a scree protector applicator to attach a scree protector onto the mobile terminal. For a mobile terminal having a non-flexible or non-curved outer surface (e.g., a mobile terminal with a common rigid display screen), a rigid scree protector (e.g., a rigid tempered glass film) is generally attached. For a mobile terminal having a curved or bendable outer surface (e.g., a curved-screen mobile terminal or a foldable-screen mobile terminal), a flexible scree protector is generally attached.

An existing scree protector applicator includes a squeegeeing assembly for squeegeeing the scree protector onto the display screen of the mobile terminal. However, such a squeegeeing assembly typically has a certain hardness and attaches the scree protector onto the mobile terminal by pressing or roller-pressing. Nevertheless, this type of squeegeeing assembly suffers from a problem of poor application effect when attaching a flexible scree protector. Specifically, when applying a scree protector onto a mobile terminal having a curved outer surface such as a curved display screen, or onto a mobile terminal having a bendable surface such as a foldable display screen, the rigid squeegeeing assembly that operates by pressing or roller-pressing may curl up the flexible scree protector, making it difficult to attach the flexible scree protector tightly onto the outer surface of the mobile terminal or to remove air bubbles, resulting in poor film application quality.

### SUMMARY

In order to solve shortcomings in existing technologies, the present disclosure is to provide a screen protector applicator to solve above technological problems.

A screen protector applicator includes a support assembly configured to support a mobile terminal and a screen protector assembly; and a squeegeeing assembly, configured to be arranged on a side of the screen protector assembly facing away from the mobile terminal and is movably connected to the support assembly. The squeegeeing assembly includes a flexible squeegeeing element configured to apply a pressure onto the screen protector assembly during movement of the squeegeeing assembly relative to the screen protector assembly, so as to attach the screen protector onto the mobile terminal.

Beneficial Effects of the present disclosure: The flexible squeegeeing element presses the screen protector assembly when the squeegeeing assembly moves relative to the screen protector assembly, thereby enabling the screen protector to be attached to the mobile terminal. Thus, even when attaching a flexible screen protector, issues such as rolling up the flexible screen protector, difficulty in pressing the flexible screen protector tightly, or difficulty in eliminating air bubbles are less likely to occur, thereby improving the film application effect.

Additionally, the squeegeeing assembly includes a mounting element and the flexible squeegeeing element. The mounting element includes a top portion and a bottom portion opposite to the top portion. The flexible squeegeeing element is mounted on the bottom portion, and the bottom portion is located between the flexible squeegeeing element and the top portion. The flexible squeegeeing element includes two first surfaces facing away from the top portion, the two first surfaces gradually approaching each other in a direction away from the top portion, and forming a squeegeeing edge at a junction of the two first surfaces. With such arrangement, the squeegeeing assembly achieves film squeegeeing by using a single squeegeeing edge. Compared with existing technical solutions that use a single surface to complete the film squeegeeing, it can effectively reduce friction and improve the user experience. Especially for mobile terminals with a wide screen like a foldable screen, the user experience is excellent.

### BRIEF DESCRIPTION OF THE DRAWINGS

FIG. 1 is a schematic view of a screen protector applicator according to a first embodiment of the present disclosure.

FIG. 2 is a schematic view of the screen protector applicator according to the first embodiment of the present disclosure, with a cover being removed.

FIG. 3 illustrate a variation state of the screen protector applicator in FIG. 2.

FIG. 4 is a schematic view of a squeegeeing assembly of the screen protector applicator according to the first embodiment of the present disclosure.

FIG. 5 is a schematic view of a mounting element of the screen protector applicator according to the first embodiment of the present disclosure.

FIG. 6 is a schematic view of a flexible squeegeeing element of the screen protector applicator according to the first embodiment of the present disclosure.

FIG. 7 is a schematic view of a squeegeeing edge of the screen protector applicator according to the first embodiment of the present disclosure, where the squeegeeing edge includes two inclined edges.

FIG. 8 is a schematic view of a variation of the squeegeeing edge of the screen protector applicator according to the first embodiment of the present disclosure, where the squeegeeing edge is arc-shaped.

FIG. 9 is a schematic view of a base of the screen protector applicator according to the second embodiment of the present disclosure.

FIG. 10 is a schematic view of a placement seat of the screen protector applicator according to the first embodiment of the present disclosure.

FIG. 11 is a schematic view of a screen protector assembly of the screen protector applicator according to the first embodiment of the present disclosure.

FIG. 12 is a schematic view of the screen protector assembly of the screen protector applicator according to the first embodiment of the present disclosure, with a positioning film being removed.

FIG. 13 illustrates an end of a pull tab being connected to a connection portion according to the first embodiment of the present disclosure.

FIG. 14 illustrates sliding of the placement seat to a position where the squeegeeing assembly presses against the protective film and the release film begins be peeled off from the protective film according to the first embodiment of the present disclosure.

FIG. 15 is a cross-sectional view of the screen protector applicator applying the protective film onto the mobile terminal according to the first embodiment of the present disclosure.

FIG. 16 is a schematic view of the mobile terminal in FIG. 15 in an extended state.

FIG. 17 is a schematic view of the mobile terminal in FIG. 15 in a folded state.

FIG. 18 is a schematic view of a screen protector applicator according to a second embodiment of the present disclosure.

FIG. 19 is a schematic view of the screen protector applicator according to the second embodiment of the present disclosure, with a cover being removed.

FIG. 20 is an exploded view of the screen protector applicator according to the sixth embodiment of the present disclosure.

FIG. 21 is a schematic view of a mounting element of the screen protector applicator according to the second embodiment of the present disclosure.

FIG. 22 is a schematic view of a housing of the screen protector applicator according to the second embodiment of the present disclosure.

FIG. 23 is an enlarged view of the portion A in FIG. 22.

FIG. 24 is a schematic view of a cover of the screen protector applicator according to the second embodiment of the present disclosure.

FIG. 25 is an enlarged view of the portion B in FIG. 24.

FIG. 26 is a schematic view of a screen protector applicator according to a third embodiment of the present disclosure.

FIG. 27 is a schematic view of the screen protector applicator according to the third embodiment of the present disclosure from another perspective.

FIG. 28 is a schematic view of the screen protector applicator according to the third embodiment of the present disclosure in another state.

FIG. 29 is an enlarged view of the portion A′ in FIG. 28.

FIG. 30 is a schematic view of a support assembly of the screen protector applicator according to the third embodiment of the present disclosure.

FIG. 31 is an enlarged view of the portion B′ in FIG. 30.

FIG. 32 is a schematic view illustrating cooperation of a mounting element and a first extension section according to the third embodiment of the present disclosure.

FIG. 33 is a schematic view of the mounting element and a squeegeeing assembly according to the third embodiment of the present disclosure.

FIG. 34 is an enlarged view of the portion C′ in FIG. 33.

FIG. 35 is a schematic view of the support assembly of the screen protector applicator according to the third embodiment of the present disclosure from another perspective.

FIG. 36 is a schematic view of a screen protector applicator according to a fourth embodiment of the present disclosure.

FIG. 37 is a schematic view of a squeegeeing assembly of the screen protector applicator according to the fourth embodiment of the present disclosure.

FIG. 38 is a schematic view of a screen protector applicator according to a fifth embodiment of the present disclosure, with a cover being removed.

FIG. 39 is a schematic view of a squeegeeing assembly of the screen protector applicator according to the fifth embodiment of the present disclosure

### DETAILED DESCRIPTION OF THE EMBODIMENTS

In order to make objectives, technical solutions, and effects of the present disclosure clearer and more definite, the present disclosure is further described in detail below with reference to accompanying drawings and embodiments. It should be understood that specific embodiments described herein are merely for explaining the present disclosure and are not intended to limit the present invention.

### Embodiment I

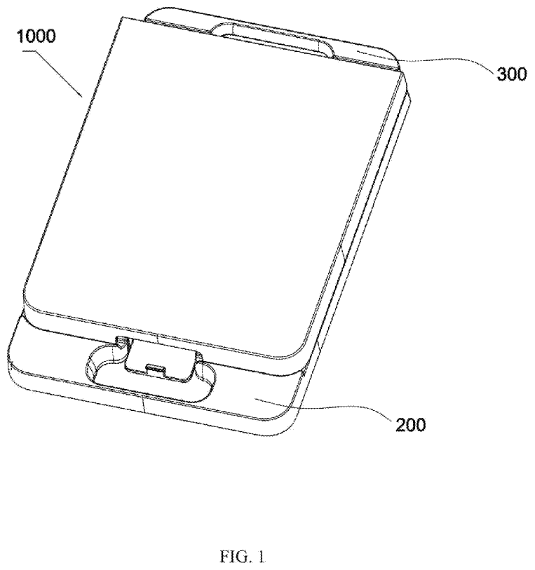

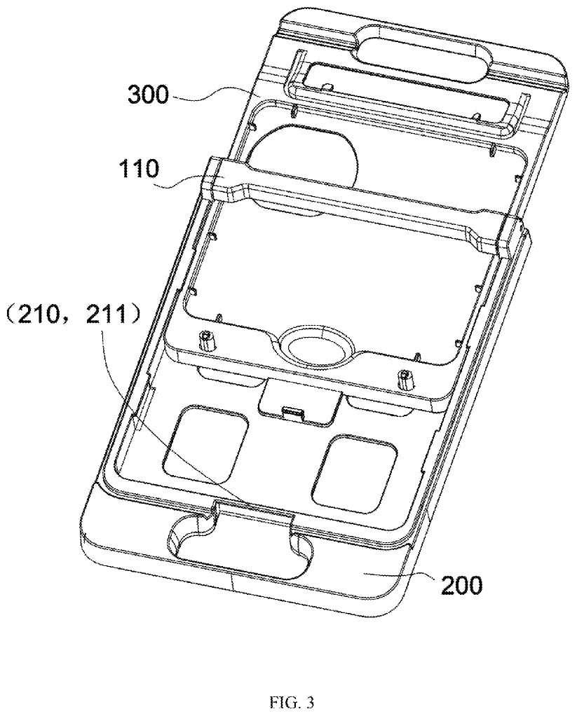

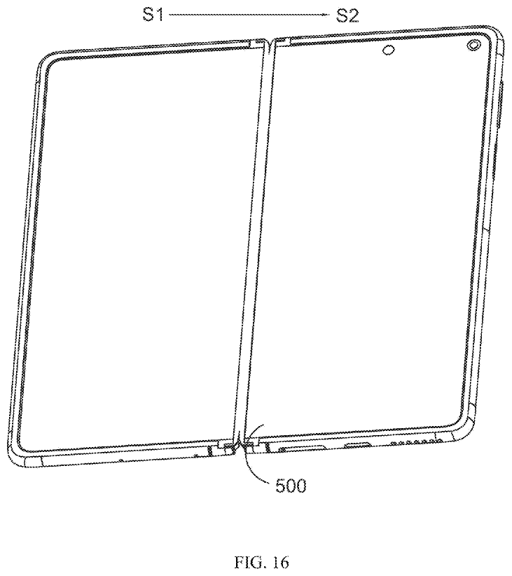

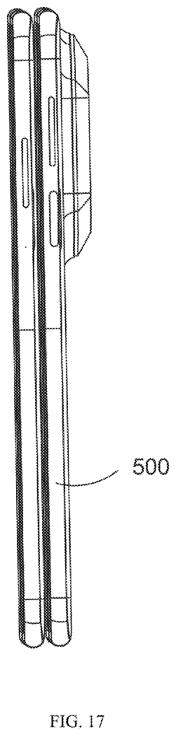

Please referring to FIGS. 1-17, a first embodiment of the present disclosure provides a screen protector applicator 1000. The screen protector applicator 10 includes a support assembly 100a and a squeegeeing assembly 100. The support assembly 100a is configured to support a mobile terminal 500 and a screen protector assembly 400. The squeegeeing assembly 100 is configured to be arranged on a side of the screen protector assembly 400 facing away from the mobile terminal 500 and is movably connected to the support assembly 100a. The squeegeeing assembly 100 includes a flexible squeegeeing element 120. The flexible squeegeeing element 120 is configured to press against the screen protector assembly 400 when the squeegeeing assembly 100 moves relative to the screen protector assembly 400, thereby causing the screen protector assembly 400 to be attached onto the mobile terminal 500.

The beneficial effect of the screen protector applicator 1000 provided by the first embodiment of the present disclosure is that the flexible squeegeeing element 120 presses against the screen protector assembly 400 when the squeegeeing assembly 100 moves relative to the screen protector assembly 400, thereby allowing the screen protector assembly 400 to be attached onto the mobile terminal 500. Thus, even for a screen protector assembly 400 that is a flexible screen protector, phenomena such as curling up the flexible screen protector, difficulty in attaching the flexible screen protector tightly onto the mobile terminal 500, or difficulty in removing air bubbles are less likely to occur, improving the screen protector application quality.

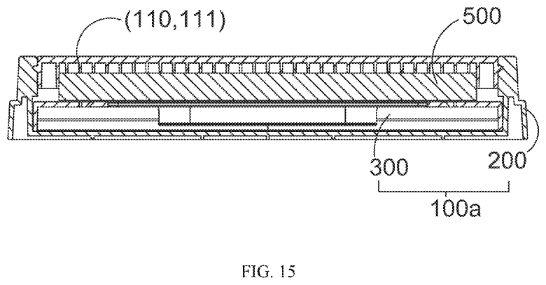

As shown in FIGS. 15 to 17, the mobile terminal provided by the first embodiment of the present disclosure is a foldable-screen mobile terminal. However, it is understandable that the above-mentioned screen protector applicator 1000 has a good application effect when attaching a flexible screen protector, but it can further be used for attaching a rigid screen protector (e.g., a tempered glass film) onto the outer surface of an ordinary mobile terminal 500, and is not limited to only attaching flexible screen protector onto the outer surface of a mobile terminal 500 having a curved or bendable surface.

In this embodiment, the material of the flexible squeegeeing element 120 may include foam. The foam is configured to contact and press against the screen protector assembly 400 when the squeegeeing assembly 100 moves relative to the screen protector assembly 400. Specifically, the foam can directly contact and press against the screen protector assembly 400 in a translational movement.

Specifically, the squeegeeing assembly 100 may be slidably connected to the support assembly 100a, so that when the squeegeeing assembly 100 slides relative to the screen protector assembly 400, the flexible squeegeeing element 120 presses the screen protector assembly 400 from one side S1 of the mobile terminal 500 to the other side S2, thereby causing the screen protector assembly 400 to be attached onto the mobile terminal 500 from one side of the mobile terminal 500 to the other side.

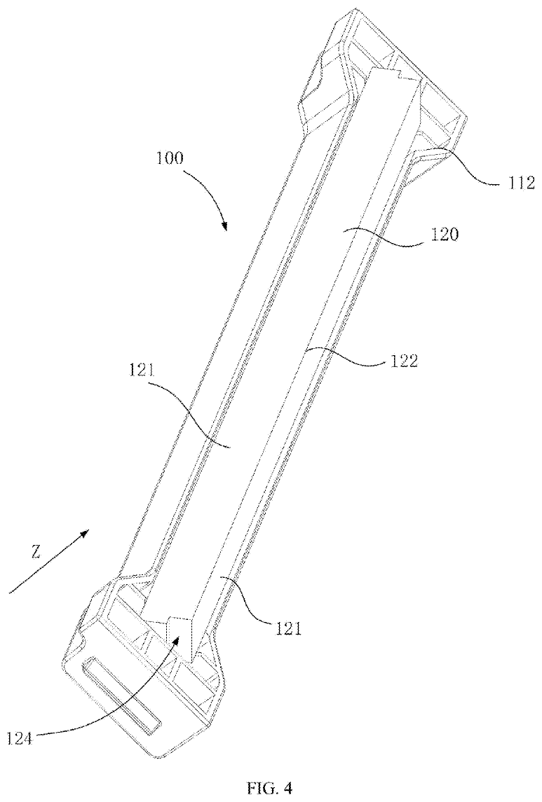

Specifically, the squeegeeing assembly 100 further includes a mounting element 110, and the flexible squeegeeing element 120 is fixed onto the mounting element 110. The mounting element 110 includes a top portion 111 and a bottom portion 112 opposite the top portion 111. The flexible squeegeeing element 120 is installed on the bottom portion 112, and the bottom portion 112 is located between the flexible squeegeeing element 120 and the top portion 111. The flexible squeegeeing element 120 includes two first surfaces 121 facing away from the top portion 111. The two first surfaces 121 gradually approach each other in a direction away from the top portion 111 (refer to the Z direction in FIG. 4), and a squeegeeing edge 122 is formed at a junction of the two first surfaces 121.

By configurations in this embodiment, the squeegeeing assembly 100 performs squeegeeing using a single edge. Compared with existing technological solutions where squeegeeing is performed using a surface, the friction can be effectively reduced, improving the user experience. Particularly for a mobile terminal with a large width, such as a foldable-screen mobile terminal, the user experience is excellent.

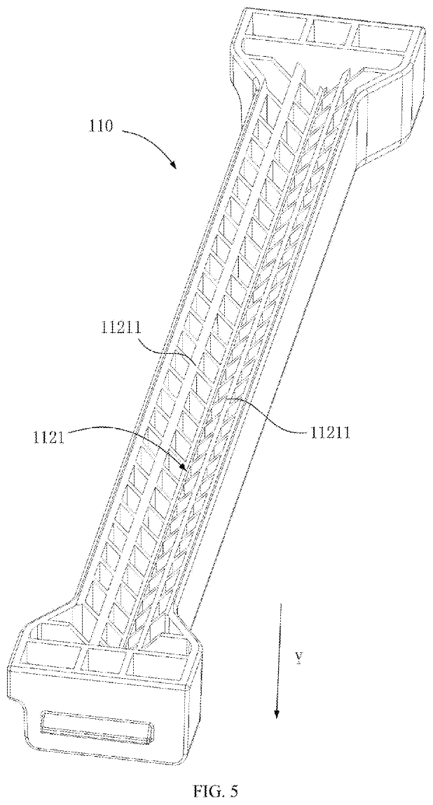

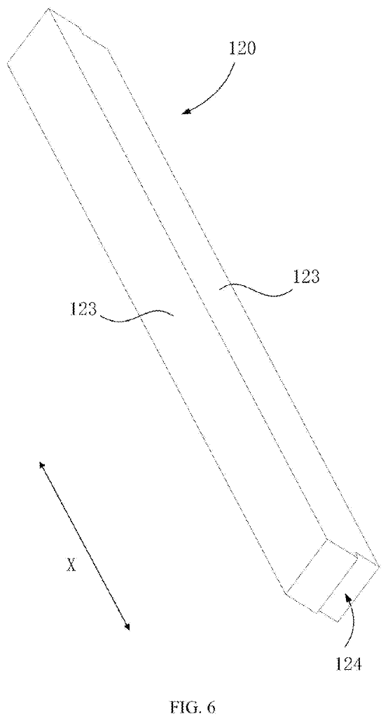

Referring to FIGS. 5 and 6, in a specific embodiment, the bottom portion 112 of the mounting element 110 has two bottom walls 11211. The two bottom walls 11211 are inclined relative to each other to form a mounting groove 1121. The two bottom walls 11211 gradually approach each other in a direction toward the top portion 111 of the mounting element 110 (refer to the Y direction in FIG. 5). The flexible squeegeeing element 120 includes two second surfaces 123 respectively opposite to the two first surfaces 121. The two second surfaces 123 are respectively supported on the two bottom walls 11211, so that the flexible squeegeeing element 120 is obliquely arranged on the mounting element 110.

Specifically, the flexible squeegeeing element 120 is obliquely arranged on the mounting element 110, so that the flexible squeegeeing element 120 includes the two first surfaces 121 facing away from the top portion 111 of the mounting element 110 of the squeegeeing assembly 100. The two first surfaces 121 gradually approach each other in the direction away from the top portion 111 and form the squeegeeing edge 122 for squeegeeing.

Referring to FIGS. 5 and 6, in a specific embodiment, one of the second surfaces 123 may be adhered to the corresponding bottom wall 11211 to achieve the positional mounting of the flexible squeegeeing element 120. Alternatively, both second surfaces 123 may be respectively adhered to the two bottom walls 11211 to achieve the positional mounting of the flexible squeegeeing element 120. The adhesive mounting method is simple and easy to operate.

Referring to FIGS. 6 to 8, in some embodiments, the squeegeeing edge 122 includes two end portions 1221 opposite each other in a length direction thereof (refer to the X direction in FIG. 6), and a middle portion 1222 located between the two end portions 1221. The middle portion 1222 protrudes from the two end portions 1221 in the direction away from the top portion 111.

Specifically, since the middle portion 1222 in this embodiment protrudes from the two end portions 1221 in the direction away from the top portion 111, it facilitates pushing the gas in the middle towards both sides during squeegeeing, which helps to promote the discharge of gas from both sides of the screen protector 410 and reduce the residual bubble rate. Particularly for a mobile terminal with a large width and a folding crease, such as a foldable-screen mobile terminal, the residual bubble rate can be greatly reduced.

It is worth mentioning that there are many specific embodiments in which the middle portion 1222 protrudes from the two end portions 1221 in the direction away from the top portion 111 to facilitate the discharge of gas from both sides of the screen protector 410 and reduce the residual bubble rate. The embodiments are not limit here. Two exemplary embodiments are described below for illustration.

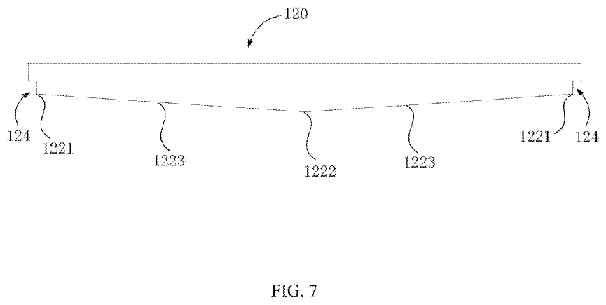

Referring to FIG. 7, in a specific embodiment, the squeegeeing edge 122 includes two inclined edges 1223 arranged at an angle. The two end portions 1221 are respectively located on sides of the two inclined edges 1223 facing away each other, and the middle portion 1222 is located at a position where the two inclined edges 1223 are connected with each other. With such an arrangement, the middle portion 1222 can protrude from the two end portions 1221 in the direction away from the top portion 111, achieving the beneficial effect of facilitating gas discharge from both sides of the protective film 410 and reducing the residual bubble rate.

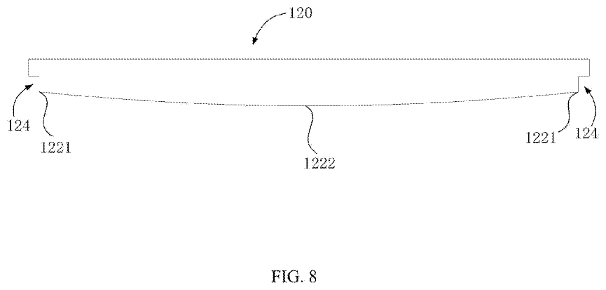

Referring to FIG. 8, in another specific embodiment, the squeegeeing edge 122 is arcuate (curved). With such an arrangement, the middle portion 1222 can protrude from the two end portions 1221 in the direction away from the top portion 111, achieving the beneficial effect of facilitating gas discharge from both sides of the protective film 410 and reducing the residual bubble rate. It is worth mentioning that the arcuate squeegeeing edge 122 provides a better gas discharge effect, and therefore the arcuate squeegeeing edge 122 is preferred in the present application.

It is worth mentioning that, in order to ensure that gas can be discharged from both sides of the screen protector 410, a height difference between the middle portion 1222 and the end portions 1221 should not be too large or too small. If the height difference between the middle portion 1222 and the end portions 1221 is too large, the gas pushed from the middle to both sides may be difficult to be squeegeed out. If the height difference between the middle portion 1222 and the end portions 1221 is too small, it is not conducive to pushing the gas from the middle portion 1222 to both sides. Therefore, in a specific embodiment, the height difference between the middle portion 1222 and the two end portions 1221 is greater than or equal to 0.5 mm and less than or equal to 1.5 mm. Such an arrangement not only facilitates pushing the gas from the middle portion 1222 to both sides, but also facilitates squeegeeing out the gas pushed to both sides.

Specifically, the height difference between the middle portion 1222 and the two end portions 1221 can be 0.5 mm, 0.7 mm, 0.9 mm, 1 mm, 1.2 mm, 1.4 mm, 1.5 mm, or any other value greater than or equal to 0.5 mm and less than or equal to 1.5 mm. This embodiment does not limit them.

Referring to FIGS. 6 to 8, in a specific embodiment, the squeegeeing edge 122 includes two end portions 1221 opposite to each other in the length direction thereof, and notches 124 are respectively provided on sides of the two end portions 1221 that are away from each other.

Specifically, considering that the edges of a mobile terminal may be protruding, the squeegeeing edge 122 must not extend beyond the edges of the mobile terminal; otherwise, gas discharge would be affected, resulting in a high residual bubble rate. Therefore, in the prior art, it is necessary to customize the flexible squeegeeing element 120 with a corresponding length according to an actual size of the mobile terminal. However, this approach is very costly, and if the sales volume of a certain mobile terminal model is misestimated, the corresponding flexible squeegeeing elements 120 may become overstocked. In this embodiment, by designing a flexible squeegeeing element 120 with a relatively large length and forming corresponding notches 124 according to the sizes (e.g. widths) of different mobile terminals, the flexible squeegeeing element 120 can be adapted to different mobile terminals. In this way, even if the sales volume of a certain mobile terminal model is misestimated, overstocking of the flexible squeegeeing element 120 can be effectively avoided. Therefore, implementing this embodiment can effectively reduce production costs.

In some embodiments, the flexible squeegeeing element 120 is made of EVA foam. EVA foam has moderate hardness and softness, is elastic, helps ensure film application quality, and can be recycled repeatedly, causing less harm to the environment.

As shown in FIGS. 1-3, 9, and 10, in this embodiment, the support assembly 100a may include a base 200 and a placement seat 300. The squeegeeing assembly 100 is arranged on the base 200. The placement seat 300 is used for placing the mobile terminal and the screen protector assembly 400. The placement seat 300 is slidably arranged on the base 200 and located on a bottom side of the squeegeeing assembly 100. However, in alternative embodiments, the base 200 may be omitted. For example, the squeegeeing assembly 100 may be directly movably connected (e.g., slidably connected) to the placement seat 300, so that the squeegeeing assembly 100 can move relative to the screen protector assembly 400 to press against the screen protector assembly 400.

By implementing this embodiment, a user can place the mobile terminal on the placement seat 300 and move the placement seat 300 to drive the mobile terminal to move relative to the squeegeeing assembly 100, so that the squeegeeing assembly 100 can be used for squeegeeing.

The squeegeeing assembly 100 of this embodiment includes the mounting element 110 and the flexible squeegeeing element 120. The mounting element 110 includes the top portion 111 and the bottom portion 112 opposite the top portion 111. The flexible squeegeeing element 120 is installed on the bottom portion 112. The flexible squeegeeing element 120 includes two first surfaces 121 facing away from the top portion 111. The two first surfaces 121 gradually approach each other in the direction away from the top portion 111, and the squeegeeing edge 122 is formed at the junction of the two first surfaces 121.

By implementing this embodiment, the squeegeeing assembly 120 performs squeegeeing using a single edge. Compared with existing technological solutions where squeegeeing is performed using a surface, the friction can be effectively reduced, improving the user experience. Particularly for a mobile terminal with a large width, such as a foldable-screen mobile terminal, the user experience is excellent.

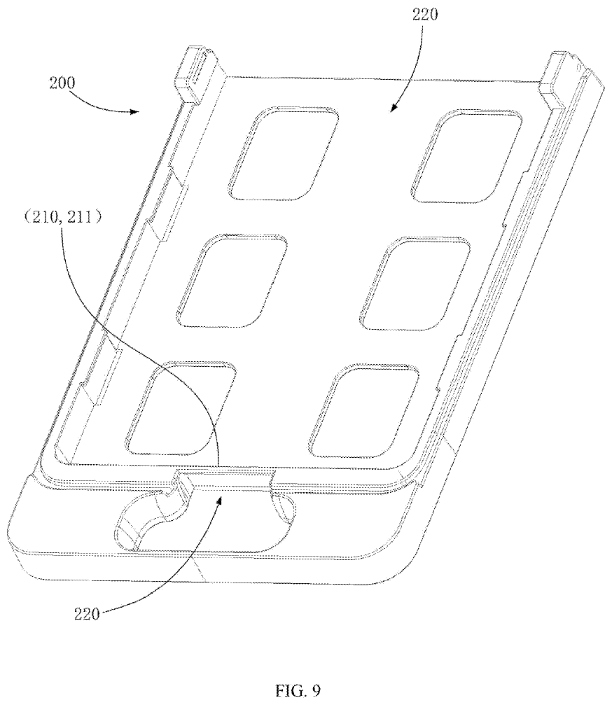

Referring to FIG. 9, in a specific embodiment, the base 200 is provided with a film-peeling structure 210 for peeling off a release film 420 of the screen protector assembly 400, so that when the placement seat 300 moves relative to the base 200, the release film 420 can be peeled off by the film-peeling structure 210.

By implementing this embodiment, the release film 420 can be peeled off using the film-peeling structure 210 while moving the placement seat 300, providing an excellent user experience.

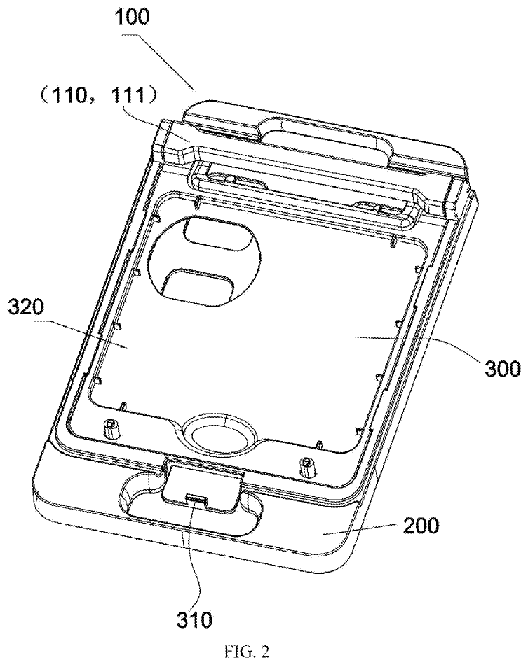

As shown in FIGS. 2, 3, 9, and 10, in a specific embodiment, the film-peeling structure 210 is a stop arm 211 arranged on a side of the base 200 facing away from the squeegeeing assembly 100. The stop arm 211 is configured to abut against a pull tab 430 connected to the release film 420. A sliding space 220 is provided under a bottom portion of the stop arm 211. The placement seat 300 has a first mounting structure 310 slidably disposed in the sliding space 220. The first mounting structure 310 is used for mounting the pull tab 430.

Specifically, during use by a user, the pull tab 430 passes over the stop arm 211, and the end of the pull tab 430 is attached to the first mounting structure 310. Then, as the placement seat 300 is moved, the stop arm 211 acts on the pull tab 430 to tension it. Gradually moving the placement seat 300 allows the stop arm 211 to progressively peel off the release film 420.

It is worth mentioning that when the placement seat 300 is not yet moved, the first mounting structure 310 may be located directly below the stop arm 211, or on a side of the stop arm 211 adjacent to the squeegeeing assembly 100, or on a side of the stop arm 211 farther from the squeegeeing assembly 100. Among these, the arrangement where the first mounting structure 310 is located on the side of the stop arm 211 facing away from the squeegeeing assembly 100 is most convenient for mounting the pull tab 430, and is therefore the preferred embodiment of the present application.

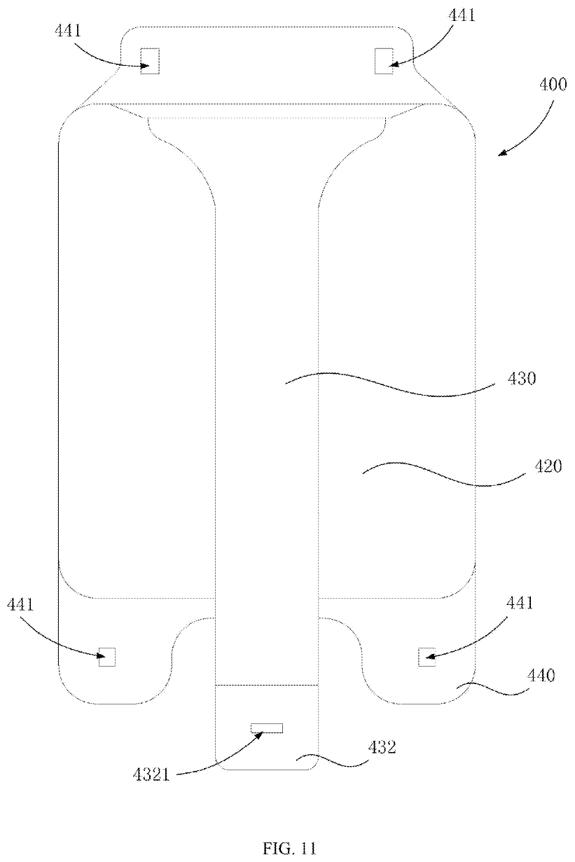

Referring to FIGS. 11 to 13, in a specific embodiment, the screen protector applicator 1000 further includes the screen protector assembly 400. The screen protector assembly 400 includes a protective film 410, the release film 420, and the pull tab 430. The release film 420 is attached to the protective film 410. The pull tab 430 is arranged on a side of the release film 420 facing away from the protective film 410. One end 431 of the pull tab 430 is connected to one end 421 of the release film, and the other end 432 of the pull tab 430 extends to protrude beyond the other end 422 of the release film. The other end 432 of the pull tab 430 is provided with a second mounting structure 4321 adapted to the first mounting structure 310.

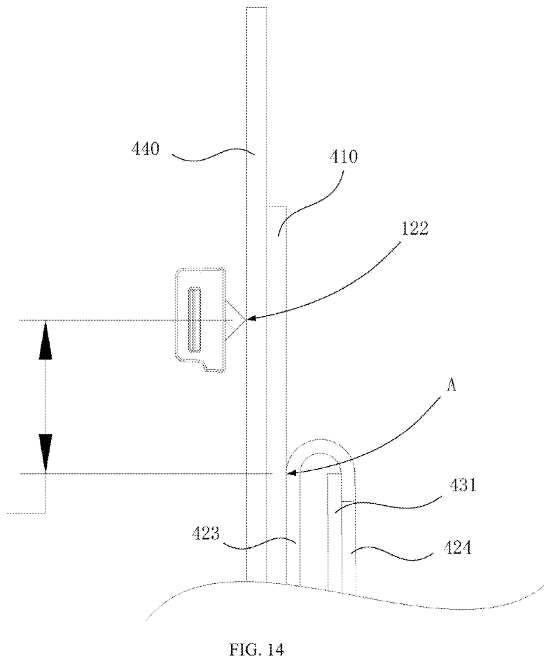

Referring to FIG. 14, in some embodiments, when the placement seat 300 is slid to a position where the squeegeeing edge 122 is in press contact with the protective film 410, the distance d between a peeling position (position A in FIG. 14) where the release film 420 begins to be peeled off from the protective film 410 and the squeegeeing edge 122 of the squeegeeing assembly 100 is greater than or equal to 0.1 mm and less than or equal to 0.8 mm.

Specifically, if the distance d between the peeling position and the squeegeeing edge 122 is too large, portions of the protective film 410 that have not yet been pressed by the squeegeeing edge 122 may first attach to the mobile terminal, which may cause misalignment of the protective film 410 or difficulty in completely removing gas. Therefore, in this embodiment, when the placement seat 300 is slid to a position where the squeegeeing edge 122 is in press contact with the protective film 410, the distance (d in FIG. 14) between the peeling position A and the squeegeeing edge 122 of the squeegeeing assembly 100 is greater than or equal to 0.1 mm and less than or equal to 0.8 mm.

Additionally, when the placement seat 300 is slid to a position where the squeegeeing structure is in press contact with the protective film 410, a distance between the peeling position and the squeegeeing structure of the squeegeeing assembly 100 may be 0.1 mm, 0.3 mm, 0.5 mm, 0.6 mm, 0.8 mm, or any other distance greater than or equal to 0.1 mm and less than or equal to 0.8 mm. This embodiment does not limit them.

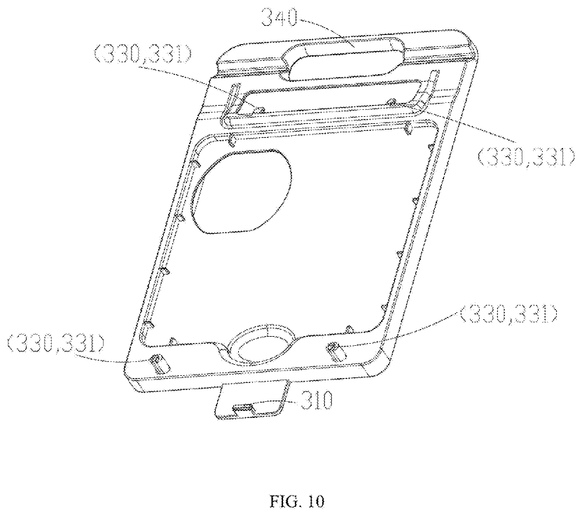

Referring to FIGS. 10 to 12, in some embodiments, the first mounting structure 310 is a locking block, and the second mounting structure 4321 is a locking opening. The pull tab 430 includes an extension section 433 between the one end 431 of the pull tab and the other end 432 of the pull tab. The thickness of the other end 432 of the pull tab is greater than the thickness of the extension section 433.

Specifically, if the other end 432 of the pull tab is too thin, the locking block may be easily come out of the locking opening. To solve this technical problem, in this embodiment, the other end 432 of the pull tab is thickened, so that the thickness of the other end 432 is greater than the thickness of the extension section 433. As a result, the other end 432 of the pull tab has higher rigidity, and the locking opening will be sufficiently stable when mounted on the locking block, effectively preventing the other end 432 of the pull tab from loosening and improving the user experience.

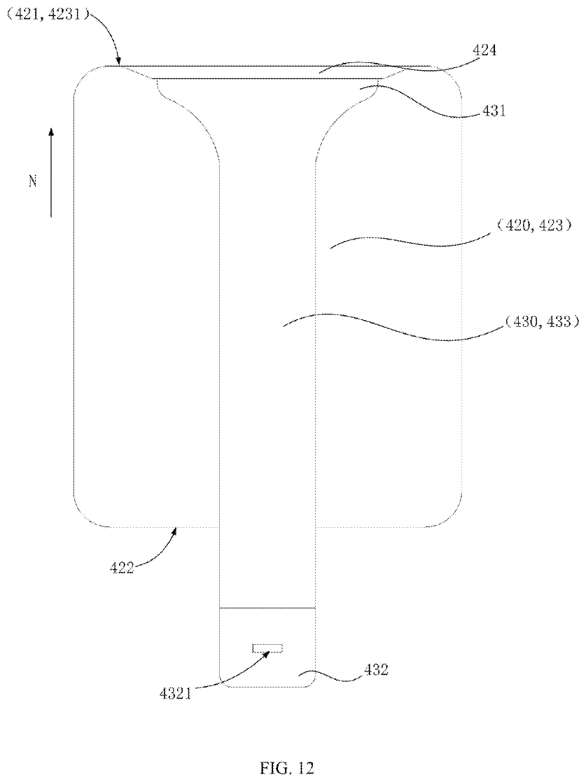

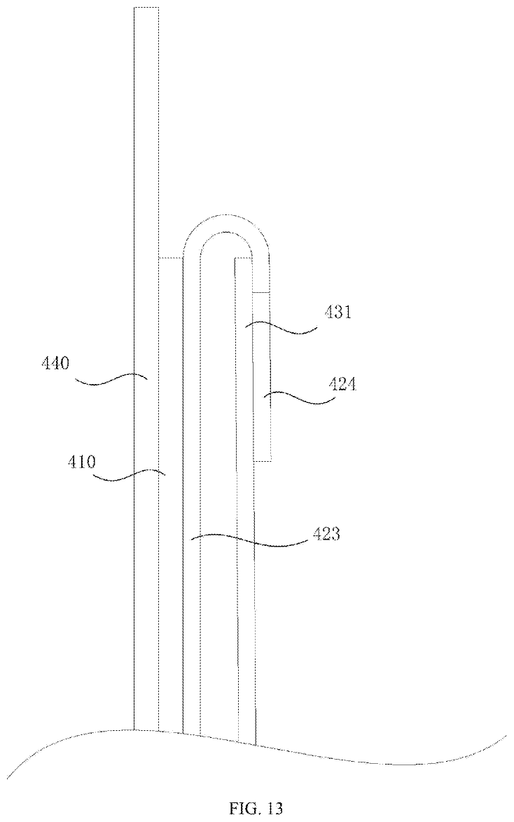

Referring to FIGS. 12 and 13, in some embodiments, the release film 420 includes a protection portion 423 and a connection portion 424. The protection portion 423 is attached to the protective film 410. The connection portion 424 is connected to one end 4231 of the protection portion. The one end 431 of the pull tab 430 is connected to the connection portion 424. The width of the connection portion 424 is smaller than the width of the protection portion 423, and the width of the connection portion 424 gradually increases in a direction towards the one end 4231 of the protection portion (refer to the N direction in FIG. 12).

Specifically, in existing technologies, when the pull tab 430 drives the protection portion 423 to peel off, the middle portion peels off first, and the two sides peel off later, resulting in inconsistent peeling progress between the middle and the sides. Thus, when the placement seat 300 is slid to a position where the squeegeeing edge 122 is in press contact with the protective film 410, the peeling positions on the sides are closer to the squeegeeing edge 122, while the peeling position at the middle is farther from the squeegeeing edge 122. Portions of the protective film 410 that have not yet been pressed by the squeegeeing edge 122 may first attach to the mobile terminal, which is unfavorable for complete air removal. To solve this technical problem, in this embodiment, the connection portion 424 is widened, and the width of the connection portion 424 gradually increases in the direction toward the protection portion 423. This can improve the synchronization of peeling between the middle and the two sides when the protection portion 423 is being peeled off, which is conducive to complete air removal.

Referring to FIG. 10, in some embodiments, the placement seat 300 is provided with a mobile terminal placement groove 320. A positioning structure 330 is provided beside the mobile terminal placement groove 320. The positioning structure 330 is used for positioning the screen protector assembly 400. Specifically, the positioning structure 330 includes a plurality of positioning locking blocks 331. The screen protector assembly 400 further includes a positioning film 440 attached to a side of the protective film 410 away from the release film 420. The positioning film 440 is provided with positioning holes 441 that cooperate with the plurality of positioning locking blocks 331, so that the positioning structure 330 can be used to position the screen protector assembly 400.

Referring to FIG. 10, in some embodiments, the placement seat 300 is provided with a handle 340 to facilitate a user pulling the placement seat 300.

### Embodiment II

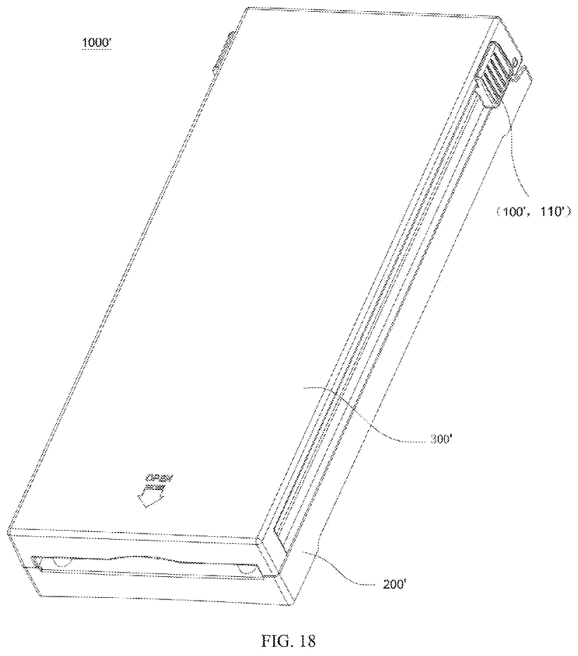

The second embodiment of the present disclosure provides a screen protector applicator 1000′. As shown in FIGS. 18-20, the screen protector applicator 1000′ includes a support assembly 200′ and a squeegeeing assembly 100′. The support assembly 200′ is configured to secure the mobile terminal to be applied with a screen protector and the screen protector assembly.

As shown in FIGS. 18-20, the squeegeeing assembly 100′ includes a mounting element 110′, a first flexible squeegeeing part 120′, and a second flexible squeegeeing element 130. The mounting element 110′ is configured to be slidably connected to the support assembly 200′ of the screen protector applicator 1000′. The first flexible squeegeeing part 120′ is arranged on the mounting element 110′, and a bottom portion of the first flexible squeegeeing part 120′ is provided with a pressure-applying flat surface 121′ configured to apply a pressure to a flat portion of a curved screen. The second flexible squeegeeing element 130′ is arranged on the mounting element 110′ and located on a rear side of the first flexible squeegeeing part 120′. A bottom portion of the second flexible squeegeeing element 130′ is provided with a pressure-applying protrusion 131′ for applying pressure to a curved portion of the curved screen. A thickness of the first flexible squeegeeing part 120′ is smaller than a thickness of the second flexible squeegeeing element 130′.

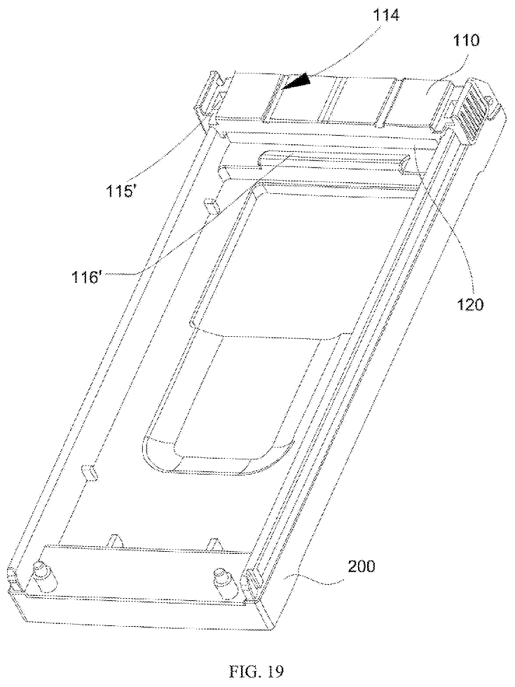

Please referring to FIGS. 18-19, the support assembly 200′ is provided with a stop protrusion 116′, configured to prevent the mobile terminal from moving during movement of the squeegeeing assembly relative to the support assembly.

Specifically, experiments have shown that the curved portion of a curved screen requires a relatively large applied force; therefore, the second flexible squeegeeing element 130′ needs to have sufficient thickness to press the curved portion. In contrast, the flat portion of the curved screen requires a relatively small applied force, so it does not need to be as thick as the second flexible squeegeeing element 130′. In the embodiment of the present disclosure, by making the first flexible squeegeeing part 120′ thinner than the second flexible squeegeeing element 130′, not only is the same film application effect as that of conventional squeegeeing assemblies achieved, but the force required to slide the squeegeeing assembly 100′ is reduced.

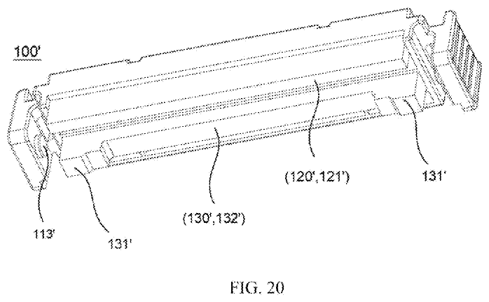

Referring to FIG. 20, in a specific embodiment, the first flexible squeegeeing part 120′ and the second flexible squeegeeing element 130′ are spaced apart from each other.

Specifically, because the first flexible squeegeeing part 120′ is flexible, during sliding of the mounting element 110′, the first flexible squeegeeing part 120′ deforms under the reaction force from the flat portion of the curved screen. If the second flexible squeegeeing element 130′ were arranged immediately adjacent to the first flexible squeegeeing part 120′, the first flexible squeegeeing part 120′ would press against the second flexible squeegeeing element 130′, causing the latter to deform. Deformation of the second flexible squeegeeing element 130′ would adversely affect the film application effect on the curved portion of the curved screen. To solve this technical problem, in this embodiment, the first flexible squeegeeing part 120′ and the second flexible squeegeeing element 130′ are spaced apart, thereby providing a deformation space for the first flexible squeegeeing part 120′. Even if the first flexible squeegeeing part 120′ deforms, it will not press against the second flexible squeegeeing element 130′.

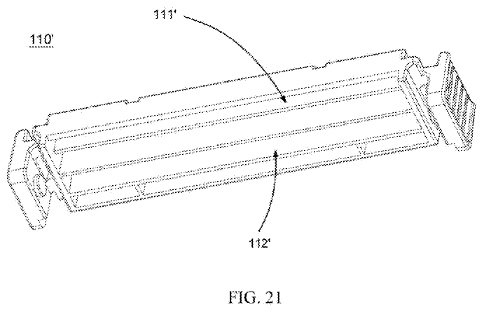

Referring to FIGS. 20 and 21, in a specific embodiment, both the first flexible squeegeeing part 120′ and the second flexible squeegeeing element 130′ are detachably connected to the mounting element 110′.

By implementing this embodiment, the first flexible squeegeeing part 120′ and the second flexible squeegeeing element 130′ can be replaced to adapt the squeegeeing assembly 100′ to different models of devices to be applied with a screen protector, which helps reduce production costs. Furthermore, when the first flexible squeegeeing part 120′ or the second flexible squeegeeing element 130′ becomes damaged, they can be replaced individually without having to replace the entire screen protector applicator 1000′.

Referring to FIGS. 20 and 21, in a specific embodiment, a bottom portion of the mounting element 110′ is provided with a first slot 111′ and a second slot 112′. The first slot 111′ and the second slot 112′ are configured to respectively engage with the first flexible squeegeeing part 120′ and the second flexible squeegeeing element 130′, so that both the first flexible squeegeeing part 120′ and the second flexible squeegeeing element 130′ can be detachably connected to the mounting element 110′.

Specifically, by implementing this embodiment, detachment and installation of the first flexible squeegeeing part 120′ and the second flexible squeegeeing element 130′ are facilitated. The first flexible squeegeeing part 120′ can be simply inserted into the first slot 111′ to achieve installation of the first flexible squeegeeing part 120′ and can be simply pulled out of the first slot 111′ to achieve detachment of the first flexible squeegeeing part 120′. Similarly, the second flexible squeegeeing element 130′ can be simply inserted into the second slot 112′ to achieve installation of the second flexible squeegeeing element 130′ and can be simply pulled out of the second slot 112′ to achieve detachment of the second flexible squeegeeing element 120′.

Referring to FIG. 20, in some embodiments, the thickness of the first flexible squeegeeing part 120′ is greater than or equal to 2 mm and less than or equal to 3.5 mm, and the thickness of the second flexible squeegeeing element 130′ is greater than or equal to 4 mm and less than or equal to 6 mm. Such an arrangement not only ensures film application effectiveness but also reduces the force required to slide the squeegeeing assembly 100′.

Referring to FIG. 20, in some embodiments, the second flexible squeegeeing element 130′ is provided with two pressure-applying protrusions 131′ spaced apart in the length direction of the pressure-applying flat surface 121′, and a connecting portion 132′ connecting the two pressure-applying protrusions 131′. The connecting portion 132′ has a relative smaller height than that of the pressure-applying flat surface 121′ so that when the squeegeeing assembly applies pressure on the mobile terminal the connection portion 132′ is farther away from the mobile terminal than the pressure-applying flat surface 121′. With this arrangement, when the second flexible squeegeeing element 130′ applies pressure to the curved portion of the curved screen, it can avoid the flat portion of the curved screen, thereby preventing an increase in the force required to slide the squeegeeing assembly 100′.

Alternatively, in some embodiments, two second flexible squeegeeing elements 130′ are provided, spaced apart in the length direction of the pressure-applying flat surface 121′, so as to form a clearance space between them for avoiding the flat portion. Such an arrangement also allows the second flexible squeegeeing elements 130′ to apply pressure to the curved portion of the curved screen while avoiding the flat portion, thereby preventing an increase in the force required to slide the squeegeeing assembly 100′.

Referring to FIG. 20, in some embodiments, both the first flexible squeegeeing part 120′ and the second flexible squeegeeing element 130′ are made of EVA foam. EVA foam has moderate hardness and softness and is resilient, which helps ensure film application effectiveness, and EVA foam is recyclable, causing less harm to the environment.

Referring to FIGS. 18-23, in a specific embodiment, the mounting element 110′ is detachably connected to the support assembly 200′.

Specifically, in conventional screen protector applicators, the mounting element cannot be detached from the housing, causing a length of the housing is relatively long. Because the housing is provided with a screen protector placement area for placing the screen protector, the mounting element must be completely slid out of the film placement area to mount the screen protector onto the housing. Therefore, the housing needs to have an area adjacent to the screen protector placement area for the mounting element to fully exit the screen protector placement area, which also necessitates a longer housing. In contrast, in this embodiment, the mounting element 110′ is detachably connected to the support assembly 200′. This allows the user to simply remove the mounting element 110′ when the screen protector needs to be mounted, and then reattach the mounting element 110′ after the screen protector is mounted. Consequently, the support assembly 200′ in this embodiment can be designed shorter, effectively reducing the transportation and storage costs of the screen protector applicator 1000′.

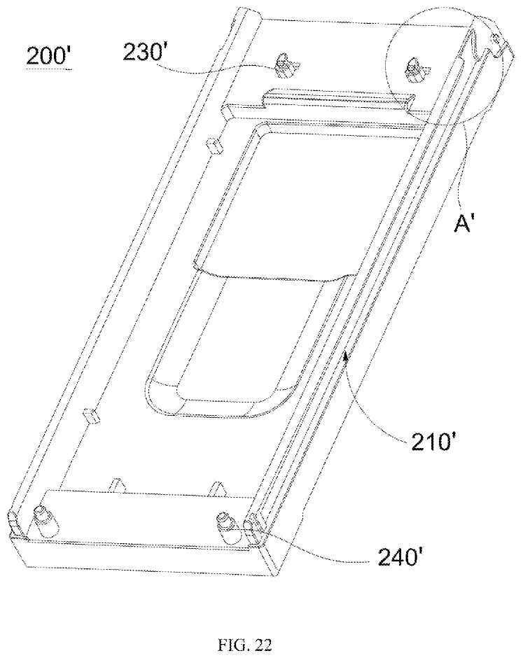

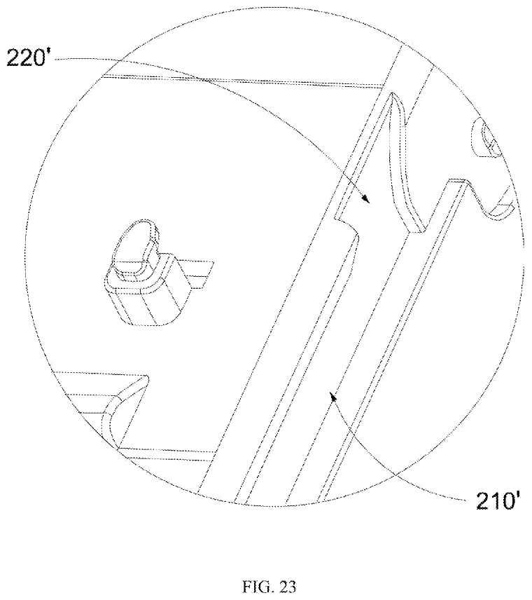

As shown in FIGS. 22 and 23, in a specific embodiment, a sidewall of the support assembly 200′ is provided with a slide groove 210′, and a through slot 220′ connecting the slide groove 210′ to the exterior is provided on the sidewall of the support assembly 200′. The mounting element 110′ is provided with a protrusion 113′ configured to cooperate with the slide groove 210′, and a size of the protrusion 113′ is smaller than that of the through slot 220′ so that the protrusion 113′ can enter the slide groove 210′ through the through slot 220′.

Specifically, because the size of the protrusion 113′ is smaller than the size of the through slot 220′, when the mounting element 110′ is moved to a position where the protrusion 113′ aligns with the through slot 220′, the protrusion 113′ can exit the slide groove 210′ through the through slot 220′, thereby allowing the mounting element 110′ to be detached from the support assembly 200′. To attach the mounting element 110′, one can simply align the protrusion 113′ with the through slot 220′ and insert the protrusion 113′ into the slide groove 210′ through the through slot 220′, which is very convenient.

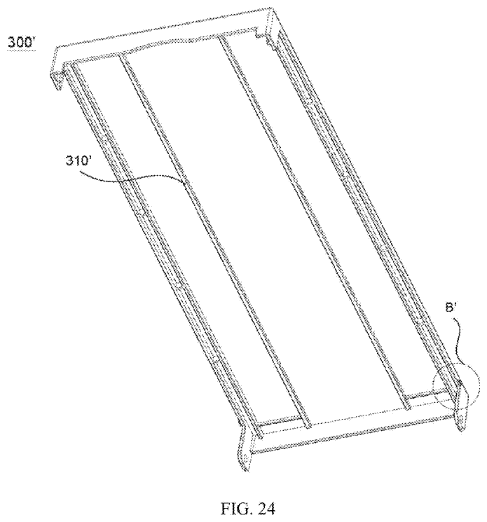

Referring to FIGS. 18, 19, and 24, in some embodiments, the screen protector applicator 1000 further includes a cover 300′ rotatably connected to the support assembly 200′. A side of the cover 300′ facing the support assembly 200′ is provided with a first guide structure 310′. A side of the mounting element 110′ facing the cover 300′ is provided with a second guide structure 114′ configured to cooperate with the first guide structure 310′. The cooperation between the first guide structure 310′ and the second guide structure 114′ provides a guiding function for the mounting element 110′, further improving the film application effect.

Referring to FIGS. 18, 19, and 24, in a specific embodiment, the first guide structure 310′ is one of a protruding rib and a groove, and the second guide structure 114′ is the other of the protruding rib and the groove.

Referring to FIGS. 18, 19, and 24, in some embodiments, two first guide structures 310′ are provided, and correspondingly two second guide structures 114′ are provided. This further enhances the guiding effect, thereby further improving the film application effect.

Referring to FIG. 22, in a specific embodiment, the support assembly 200′ includes a first support platform 230′ and a second support platform 240′. The first support platform 230′ and the second support platform 240′ are spaced apart in a length direction of the slide groove 210′ to support the screen protector on opposite sides of the screen protector. The first support platform 230′ is lower than the second support platform 240′. As a result, when the screen protector is mounted, it is placed at an incline, effectively preventing the middle portion of the screen protector from sagging and sticking to the mobile terminal before the squeegeeing assembly 100′ is used. When the squeegeeing assembly 100′ is used, it slides gradually from the side where the screen protector is closer to the mobile terminal to be applied with the screen protector to the opposite side, which helps reduce bubbles generated during film attachment and provides an excellent user experience.

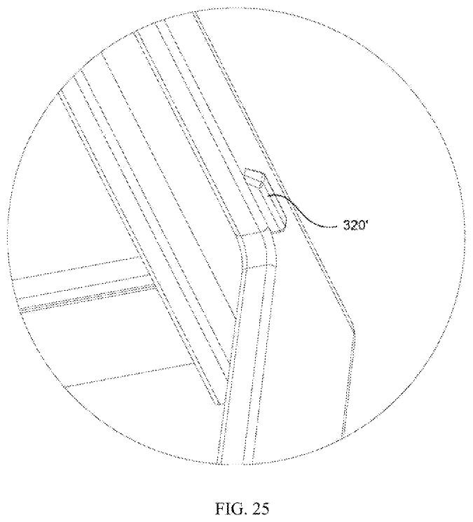

Referring to FIGS. 18 and 24-25, in some embodiments, an outer sidewall of the cover 300′ is provided with a first locking structure (e.g. a locking block 320′). The mounting element 110′ is provided with a second locking structure (e.g. a locking structure 115′) corresponding to the locking block 320′. The locking block 320′ is configured to engage with the locking structure 115′ of the mounting element 110′ when the mounting element 110′ is moved to the position where the protrusion 113′ aligns with the through slot 220′. This allows the mounting element 110′ to be detached from the support assembly 200′ simply by rotating the cover 300′, which is very convenient.

### Third Embodiment

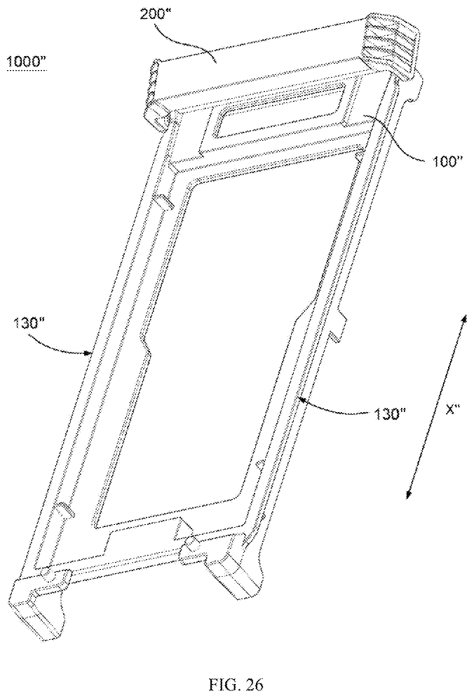

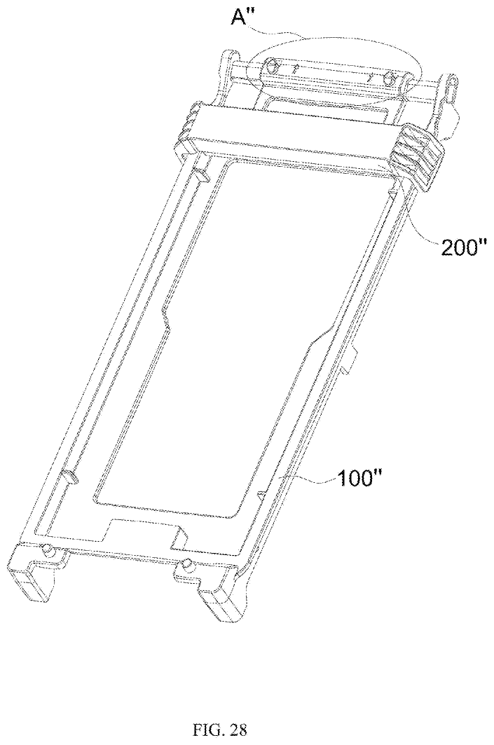

The third embodiment of the present disclosure provides a screen protector applicator 1000″. As shown in FIGS. 26-29, the screen protector applicator 1000″ includes a support assembly 100″, a mounting element 200″, and a squeegeeing assembly 300″. The support assembly 100″ is provided with a mounting groove 110″, a first positioning structure 120″, and a slide rail 130″. The mounting groove 110″ is configured to mount a mobile terminal. In a length direction of the support assembly 100″, the first positioning structure 120″ is arranged on one side of the mounting groove 110″, and the first positioning structure 120″ is configured to position the screen protector. The slide rail 130″ is arranged along the length direction of the support assembly 100″ (the X direction in FIG. 26). The mounting element 200″ is slidably connected to the support assembly 100″ via the slide rail 130″, and is rotatably connected to the support assembly 100″, so that the mounting element 200″ can rotate towards the mounting groove 110″ to cover the first positioning structure 120″, and can rotate away from the mounting groove 110″ to expose the first positioning structure 120″. The squeegeeing assembly 300″ is arranged on the mounting element 200″ and is configured to apply pressure to the protective film.

By implementing this embodiment, before mounting the screen protector, the mounting element 200″ can be rotated from a position where it covers the first positioning structure 120″ to a position where it exposes the first positioning structure 120″. In this way, the mounting element 200″ does not block the screen protector placement area, making it convenient for the user to position and mount the screen protector using the first positioning structure 120″. After the screen protector is mounted, the mounting element 200″ is simply rotated back from the position exposing the first positioning structure 120″ to the position covering the first positioning structure 120″. Then, the mounting element 200″ can be moved along the length direction of the support assembly 100″ to apply pressure to the protective film using the squeegeeing assembly 300″ on the mounting element 200″.

It is worth mentioning that in existing technologies, to prevent the mounting element from blocking the screen protector placement area, a position adjacent to the screen protector placement area is reserved in the length direction of the support assembly for the mounting element to slide out of the screen protector placement area. After implementing this embodiment, there is no need to reserve such a position in the length direction of the support assembly for the mounting element to slide out of the screen protector placement area, like in the prior art. Therefore, the support assembly 100″ of the present embodiment is shorter in length, uses less material, and can effectively reduce the production and transportation costs of the screen protector applicator 1000″.

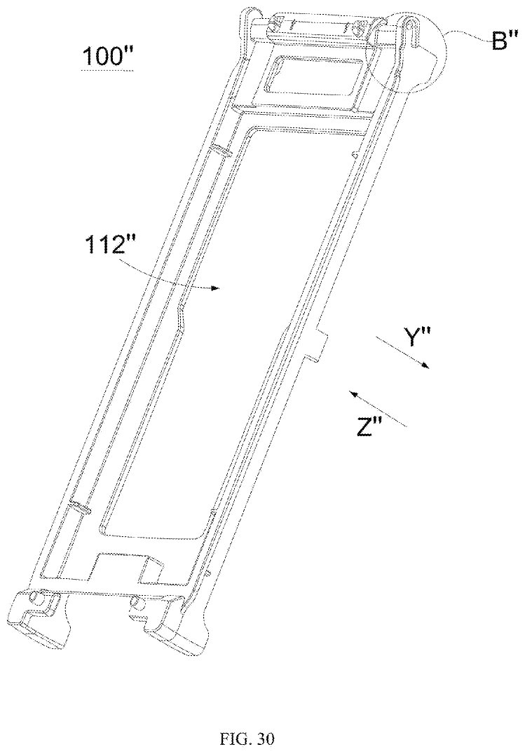

Referring to FIGS. 30-34, in a specific embodiment, the mounting element 200″ is provided with a first pivot shaft 210″, and the slide rail 130″ is a protruding rib provided on a sidewall of the support assembly 100″. The protruding rib includes a first extension section 131″, a bent section 132″, and a second extension section 133″. The first extension section 131″ is arranged along the length direction of the support assembly 100″, and the first pivot shaft 210″ is arranged at a bottom side of the first extension section 131″. One end of the bent section 132″ is connected to an end of the first extension section 131″ adjacent to the first positioning structure 120″, and the other end is bent and extends towards the bottom side of the first extension section 131″ (the Y direction in FIG. 30). The second extension section 133″ is connected to the other end of the bent section 132″ and extends towards the mounting groove 110″.

Specifically, because in this embodiment the first extension section 131″ is disposed along the length direction of the support assembly 100″ and the first pivot shaft 210″ is disposed under the first extension section 131″, when the mounting element 200″ moves along the length direction of the support assembly 100″, the first extension section 131″ effectively guides the sliding of the mounting element 200″ along the length direction of the support assembly 100″, preventing the mounting element 200″ from moving entirely away from the support assembly 100″ (the Z direction in FIG. 30″) and detaching from the support assembly 100″. The bent section 132″ and the second extension section 133″ can restrict a position of the first pivot shaft 210″ when the mounting element 200″ is rotated to expose the first positioning structure 120″, preventing the mounting element 200″ from detaching from the support assembly 100″.

Referring to FIG. 30, in a specific embodiment, a ratio of a length of the first extension section 131″ to a length of the second extension section 133′ is greater than 5.

Specifically, the second extension section 133″ is primarily configured to restrict the position of the first pivot shaft 210″ when the mounting element 200″ is rotated to expose the first positioning structure 120″, preventing the mounting element 200″ from detaching from the support assembly 100″. Therefore, the second extension section 133″ does not need to be as long as the first extension section 131″. To save material and reduce the production cost of the support assembly 100″, the ratio of the length of the first extension section 131″ to the length of the second extension section 133″ in this embodiment is greater than 5.

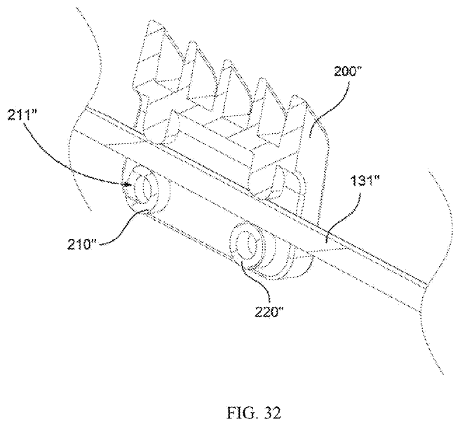

Referring to FIGS. 32-34, in some embodiments, the mounting element 200″ is further provided with a rotation limiting part 220″. The rotation limiting part 220″ is spaced apart from the first pivot shaft 210″, and the rotation limiting part 220″ is also located at a bottom side of the first extension section 131″.

Specifically, if a rotation angle of the mounting element 200″ could be adjusted during the sliding of the mounting element 200″ for screen protector application, the mounting element 200″ might rotate away from the mobile terminal. In that case, the pressure applied by the squeegeeing assembly 300″ to the protective film would be insufficient, resulting in many residual bubbles after film application and a poor user experience. Because this embodiment provides the rotation limiting part 220″ spaced apart from the mounting element 200″, and the rotation limiting part 220″ is positioned below the first extension section 131″, the rotation limiting part 220″ can cooperate with the first pivot shaft 210″ and the first extension section 131″ to restrict the rotation of the mounting element 200″.

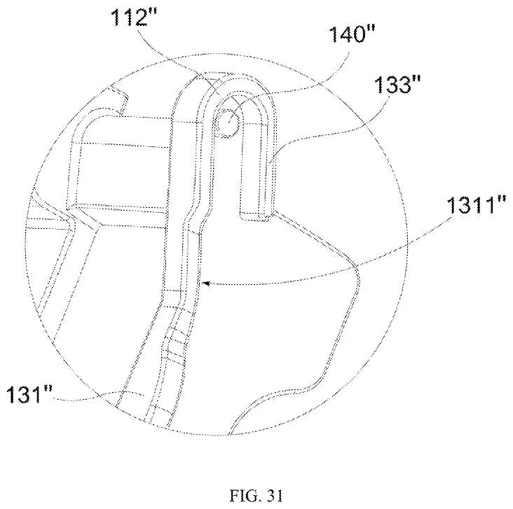

Referring to FIG. 31, in order to prevent the rotation limiting part 220″ from restricting rotation of the mounting element 200″ when the mounting element 200″ slides to the position covering the first positioning structure 120, this embodiment further provides a notch 1311 on the first extension section 131″. The length of the rotation limiting part 220″ is smaller than a depth of the notch 1311″. When the mounting element 200″ slides to the position covering the first positioning structure 120″, the rotation limiting part 220″ is directly opposite to the notch 1311, so that when the mounting element 200″ rotates, the rotation limiting part 220″ can pass through the notch 1311″, ensuring that the mounting element 200″ can rotate freely.

To prevent the first pivot shaft 210″ detaching from the support assembly 100″ through the notch 1311″ due to user mis-operation, in a specific embodiment, the length of the first pivot shaft 210″ is greater than the depth of the notch 1311″. With this arrangement, even if the first pivot shaft 210″ is directly opposite the notch 1311″, it cannot pass through the notch 1311″.

Referring to FIGS. 31-34, in some embodiments, a second pivot shaft 140″ is further provided adjacent to the bent section 132″. The second pivot shaft 140″ is located on a side of the bent section 132″ adjacent to the mounting groove 110″. An outer surface of the first pivot shaft 210″ is provided with an engaging groove 211″ adapted to the second pivot shaft 140″, so that when the mounting element 200″ slides to the position covering the first positioning structure 120″, the second pivot shaft 140″ can be inserted into the engaging groove 211″. With this arrangement, when the mounting element 200″ is flipped, the first pivot shaft 210″ can engage with the second pivot shaft 140″, preventing unnecessary wobbling during flipping and improving the stability of the mounting element 200″ when flipped.

Referring to FIGS. 30 and 31, in some embodiments, the slide rail 130″ is provided on the top of the sidewall of the support assembly 100″, and a section of the slide rail 130″ adjacent to the first positioning structure 120″ is bent and extends towards the bottom side of the support assembly 100″.

Specifically, if the slide rail 130″ were arranged linearly, when the mounting element 200″ rotates to expose the first positioning structure 120″, it would collide with a surface (e.g. a desktop) on which the support assembly 100″ is placed, and might even cause one end of the support assembly 100″ to be lifted by the mounting element 200″. To prevent the mounting element 200″ from contacting the desktop, in this embodiment, the section of the slide rail 130″ adjacent to the first positioning structure 120″ is bent and extends away from a bottom side of the support assembly. As a result, when the mounting element 200″ is moved to the rotation position, it is raised, which can effectively prevent collision with the desktop when the mounting element 200″ rotates to expose the first positioning structure 120″.

It is worth mentioning that increasing an overall thickness of the support assembly 100″ to raise the entire height of the slide rail 130″ could also prevent such collision. However, this would increase the volume and material usage of the support assembly 100″, which is not conductive to reducing production and transportation costs of the screen protector applicator 1000″.

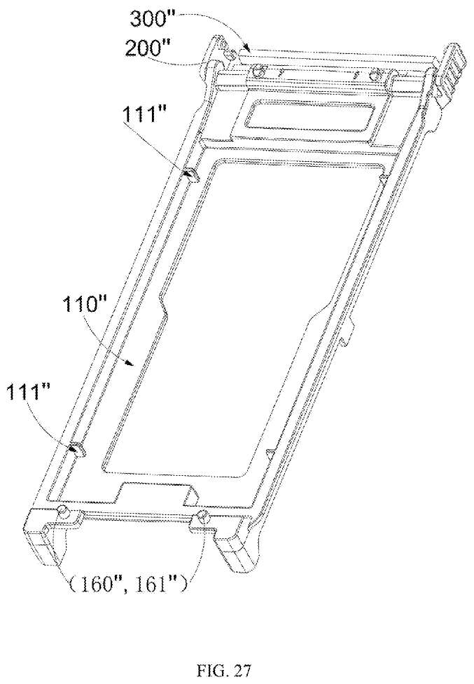

Referring to FIG. 27, in some embodiments, the screen protector applicator 1000″ may further include a positioning foam (not shown in the figures). The positioning foam can be installed in the mounting groove 110″ so that a mounting space matching the shape of the mobile terminal is formed inside the mounting groove 110″.

It is worth mentioning that the mounting groove 110″ could be formed according to the shape of the mobile terminal. However, due to the wide variety of mobile terminal models on the market, producing a dedicated support assembly 100″ for each model would lead to significant inventory accumulation and high costs. To solve this technical problem, the mounting groove 110″ can be designed to be relatively large, and a positioning foam shaped according to the contour of the mobile terminal can be installed inside the mounting groove 110″, so that a mounting space matching the shape of the mobile terminal is formed inside the mounting groove 110″. With this design, the support assembly 100″ can be adapted for multiple mobile terminal models. It is only necessary to install the corresponding positioning foam according to the model before sale, effectively reducing inventory.

In some embodiments, a mounting structure con figured to mount the positioning foam can be provided on the support assembly 100″ adjacent to the mounting groove 110″. The mounting structure may be an insertion block or an insertion slot. Referring to FIG. 27, in a specific embodiment, one of an insertion block 111″ and an insertion slot is provided on the support assembly 100 adjacent to the mounting groove 110″, and the other of the insertion block 111″ and the insertion slot is provided on the positioning foam. The insertion block 111″ and the insertion slot are adapted to each other, so that the positioning foam can be accurately installed in the mounting groove 110″ by cooperation of the insertion block 111″ and the insertion slot, preventing the mounting space defined by the positioning foam from deviating and becoming unmatching the shape of the mobile terminal.

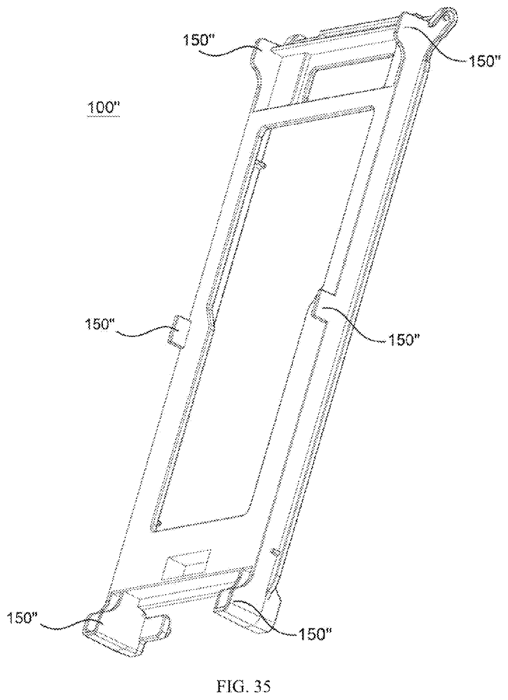

Referring to FIGS. 30 and 35, in some embodiments, a bottom of the mounting groove 110″ is provided with an avoidance opening 112″ for accommodating a camera module of the mobile terminal. A plurality of spaced-apart protrusions 150″ are provided at an edge of the support assembly 100″ on the bottom side of the support assembly 100″, so as to raise the avoidance opening 112″.

Specifically, in existing technologies, the camera module of a mobile terminal generally protrudes. To accommodate the protruding camera module, an avoidance opening is provided at the bottom of the mounting groove. If the avoidance opening is too close to the desktop on which the support assembly is placed, the camera module would contact the desktop. To prevent such contact, the existing technologies raise the avoidance opening. In the existing technologies, an annular protruding rib is provided at the edge of the support assembly on the side opposite the first positioning structure. Although such an annular protruding rib can raise the height of the avoidance opening, it consumes too much material, which is not conductive to reducing the production cost of the support assembly. To solve this technical problem, this embodiment provides a plurality of spaced-apart protrusions 150″ (arranged like bars) at the edge of the support assembly 100″ on the bottom side opposite the first positioning structure 120″ to raise the avoidance opening 112″. Compared to an annular protruding rib extending along the entire edge, this consumes less material and effectively reduces the production cost of the support assembly 100″.

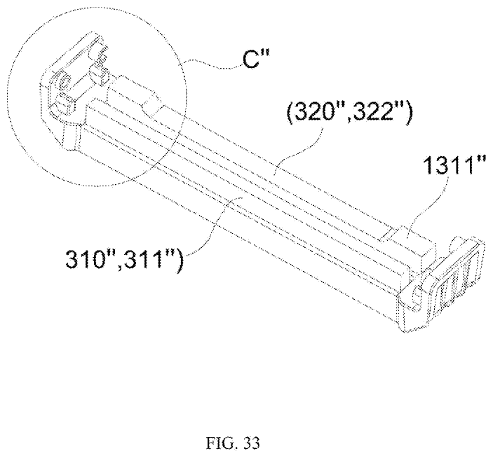

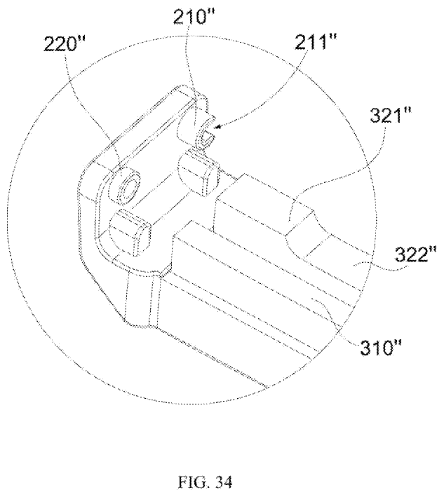

Referring to FIGS. 33 and 34, in some embodiments, the squeegeeing assembly 300″ includes a first flexible squeegeeing part 310″ and a second flexible squeegeeing element 320″. The first flexible squeegeeing part 310″ is disposed on the mounting element 200″. A bottom portion of the first flexible squeegeeing part 310″ has a pressure-applying flat surface 311″ for applying pressure to a flat portion of a curved screen. The second flexible squeegeeing element 320″ is disposed on the mounting element 200″ and is spaced apart from the first flexible squeegeeing part 310″. A bottom portion of the second flexible squeegeeing element 320″ is provided with a pressure-applying protrusion 321″ for applying pressure to a curved portion of the curved screen.

In this embodiment, two flexible squeegeeing elements (a first flexible squeegeeing part 310″ and a second flexible squeegeeing element 320″) are used to apply the protective film to a curved screen. When the mounting element 200″ is slid, the pressure-applying flat surface 311″ of the first flexible squeegeeing part 310″ first applies pressure to the flat portion of the curved screen, and then the pressure-applying protrusion 321″ of the second flexible squeegeeing element 320″ applies pressure to the curved portion of the curved screen. Compared with a film application method that uses a single squeegeeing element to apply pressure to both the flat and curved portions of the curved screen simultaneously, the method of the present disclosure applying pressure sequentially to the flat and curved portions can more effectively expel air, reduce the number of bubbles, improve film application quality, and provide an excellent user experience.

It is worth mentioning that the first flexible squeegeeing part 310″ is flexible, so during sliding of the mounting element 200″, the first flexible squeegeeing part 310″ deforms under the reaction force from the flat portion of the curved screen. If the second flexible squeegeeing element 320″ were arranged immediately adjacent to the first flexible squeegeeing part 310″, the first flexible squeegeeing part 310″ would press against the second flexible squeegeeing element 320″, causing the latter to deform. Deformation of the second flexible squeegeeing element 320″ would adversely affect the film application effect on the curved portion of the curved screen. To solve this technical problem, in this embodiment, the first flexible squeegeeing part 310″ and the second flexible squeegeeing element 320″ are spaced apart, thereby providing a deformation space for the first flexible squeegeeing part 310″. Even if the first flexible squeegeeing part 310″ deforms, it will not press against the second flexible squeegeeing element 320.

Referring to FIGS. 33 and 34, in a specific embodiment, a width of the first flexible squeegeeing part 310″ is smaller than a width of the second flexible squeegeeing element 320″.

Specifically, experiments have shown that the curved portion of a curved screen requires a relatively large applied force; therefore, the second flexible squeegeeing element 320″ needs to have sufficient width (pressure application area) to press the curved portion. In contrast, the flat portion of the curved screen requires a relatively small applied force, so it does not need to be as width as the second flexible squeegeeing element 320″. In the embodiment of the present application, by making the first flexible squeegeeing part 310″ narrower than the second flexible squeegeeing element 320″, not only is the same film application effect as that of conventional squeegeeing assemblies achieved, but the force required to slide the squeegeeing assembly and the cost of producing the first flexible squeegeeing part 310″ are also reduced.

Referring to FIGS. 33 and 34, in some embodiments, both the first flexible squeegeeing part 310″ and the second flexible squeegeeing element 320″ are made of EVA foam. EVA foam has moderate hardness and softness and is resilient, which helps ensure film application effectiveness, and the EVA foam is recyclable, causing less harm to the environment.

Referring to FIGS. 33 and 34, in some embodiments, the width of the first flexible squeegeeing part 310″ is greater than or equal to 2 mm and less than or equal to 3.5 mm, and the width of the second flexible squeegeeing element 320″ is greater than or equal to 4 mm and less than or equal to 6 mm. Such an arrangement not only ensures film application effectiveness but also reduces the force required to slide the mounting element 200″.

Referring to FIGS. 33 and 34, in some embodiments, the second flexible squeegeeing element 320″ is provided with two pressure-applying protrusions 321″ spaced apart in the length direction of the pressure-applying flat surface 311″, and a connecting portion 322″ connecting the two pressure-applying protrusions 321″. The connecting portion 322″ has a smaller height than the pressure-applying flat surface 311 so that when the squeegeeing assembly 300″ applies pressure to the mobile terminal, the connection portion 322″ is farther from the mobile terminal than the pressure-applying flat surface 311. With this arrangement, when the second flexible squeegeeing element 320″ applies pressure to the curved portion of the curved screen, it can avoid the flat portion of the curved screen.

Optionally, two second flexible squeegeeing elements 320″ are provided, spaced apart in the length direction of the pressure-applying flat surface 311″, so as to form a clearance space between them for avoiding the flat portion. Such an arrangement also allows the second flexible squeegeeing elements 320″ to apply pressure to the curved portion of the curved screen while avoiding the flat portion, thereby preventing an increase in the force required to slide the squeegeeing assembly.

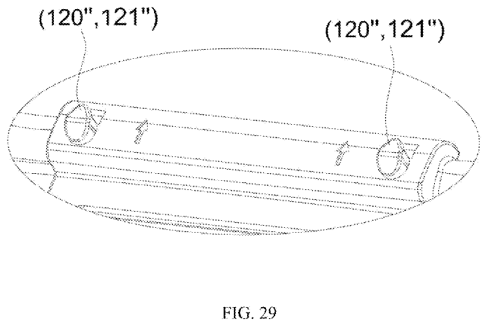

Referring to FIG. 29, in some embodiments, the first positioning structure 120″ includes two positioning hooks 121″ spaced apart from each other. The screen protector is provided with two hanging holes adapted to the positioning hooks 121, so that the screen protector can be hooked onto the support assembly 100″ using the positioning hooks 121″ in cooperation with the hanging holes.

Additionally, referring to FIG. 27, the support assembly 100″ is further provided with a second positioning structure 160″. The second positioning structure 160″ is arranged on a side of the mounting groove 110″ away from the first positioning structure 120″. The second positioning structure 160″ includes two spaced-apart pins 161″. The screen protector is provided with two insertion holes adapted to the pins 161″. In this way, the cooperation of the pins 161″ and the insertion holes can improve the stability of the screen protector when mounted on the support assembly 100″.

In the embodiments of the present disclosure, the mobile terminals described in this application include, but are not limited to, mobile phones, watches, and tablet computers.

### Fourth Embodiment

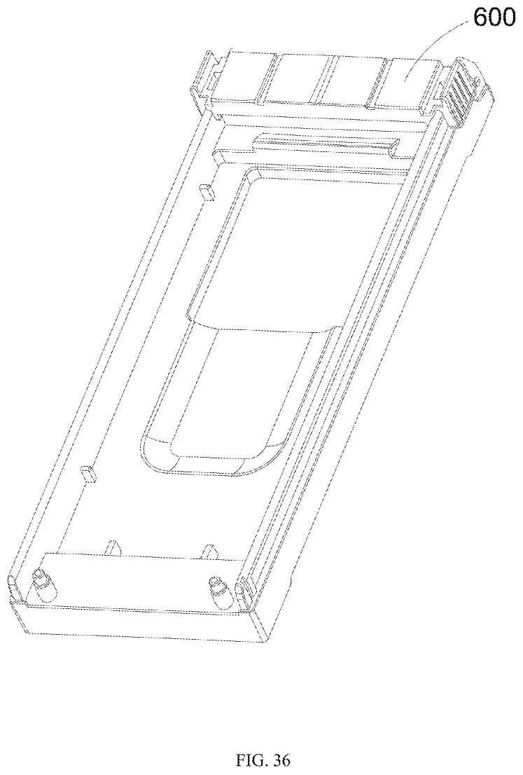

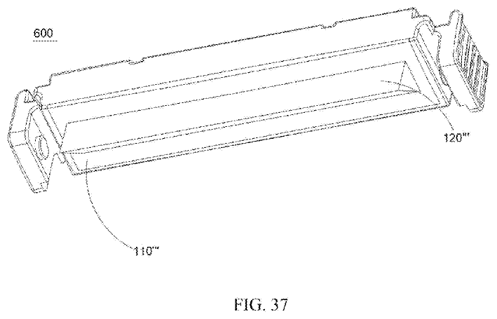

Please refer to FIGS. 36 to 37, a fourth embodiment of the present disclosure provides a screen protector applicator. The screen protector applicator of this embodiment is substantially the same as the screen protector applicator of the second embodiment. The main difference between the two lies in the squeegeeing assembly 600. The squeegeeing assembly 600 in the fourth embodiment includes a mounting element 110″′ with a similar structure with the mounting element in the second embodiment and a squeegeeing element 120″′ with a squeegeeing edge like in the first embodiment. Therefore, with the screen protector applicator of the fourth embodiment, a flexible protective film can also be attached to a mobile terminal by sliding and pressing.

### Fifth Embodiment

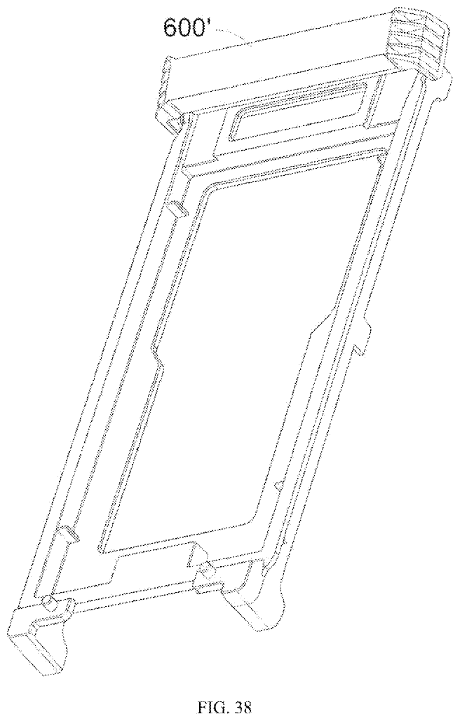

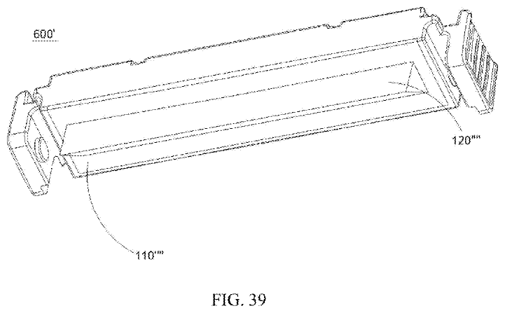

Please refer to FIGS. 38 to 39, a fifth embodiment of the present application provides a screen protector applicator. The screen protector applicator of this embodiment is substantially the same as the screen protector applicator of the third embodiment. The main difference between the two lies in the squeegeeing assembly 600′. The squeegeeing assembly 600′ in the fifth embodiment includes a mounting element 110″″′ with a similar structure with the mounting element in the second embodiment and a squeegeeing element 120″″′ with a squeegeeing edge like in the first embodiment. Therefore, with the screen protector applicator of the fifth embodiment, a flexible protective film can also be attached to a mobile terminal by sliding and pressing.

Although specific descriptions have been provided in conjunction with the accompanying drawings and embodiments in the present disclosure, it is understood that the above descriptions do not limit this invention in any form. Those skilled in the art can make deformations and changes to the present disclosure according to needs without deviating from the essence and scope of this invention, and these deformations and changes all fall within the scope of this invention.

What is claimed is:

1. A screen protector applicator, comprising:
a support assembly, configured to support a mobile terminal and a screen protector assembly; and
a squeegeeing assembly, configured to be arranged on a side of the screen protector assembly facing away from the mobile terminal and is movably connected to the support assembly; the squeegeeing assembly comprises a flexible squeegeeing element configured to apply a pressure onto the screen protector assembly during movement of the squeegeeing assembly relative to the screen protector assembly, so as to attach the screen protector onto the mobile terminal.

2. The screen protector applicator according to claim 1, wherein the flexible squeegeeing element comprises a foam configured to apply the pressure onto the screen protector assembly during movement of the squeegeeing assembly relative to the screen protector assembly.

3. The screen protector applicator according to claim 1, wherein the squeegeeing assembly is slidably connected to the support assembly, such that when the squeegeeing assembly slides relative to the screen protector assembly, the flexible squeegeeing element presses the screen protector assembly from one side of the mobile terminal to another side of the mobile terminal, thereby causing the screen protector assembly to be attached onto the mobile terminal from the one side to the other side.

4. The screen protector applicator according to claim 3, wherein
the squeegeeing assembly further comprises a mounting element; the mounting element comprises a top portion and a bottom portion opposite the top portion; the flexible squeegeeing element is mounted on the bottom portion, and the bottom portion is located between the flexible squeegeeing element and the top portion; and
the flexible squeegeeing element comprises two first surfaces facing away from the top portion, the two first surfaces gradually approaching each other in a direction away from the top portion, and forming a squeegeeing edge at a junction of the two first surfaces.

5. The screen protector applicator according to claim 4, wherein the squeegeeing edge comprises two opposite ends in a length direction thereof, and a middle portion located between the two opposite ends, the middle portion protruding away from the top portion relative to the two opposite ends.

6. The screen protector applicator according to claim 5, wherein
the squeegeeing edge is arc-shaped; or
the squeegeeing edge comprises two inclined edges forming an angle, the two opposite ends being respectively located on sides of the two inclined edges away from each other, and the middle portion being located where the two inclined edges adjoin.

7. The screen protector applicator according to claim 5, wherein a height difference between the middle portion and the two opposite ends is greater than or equal to 0.5 mm and less than or equal to 1.5 mm; and/or
the squeegeeing edge comprises two opposite ends in a length direction thereof, and a notch is provided on a side of each of the two opposite ends facing away from each other.

8. The screen protector applicator according to claim 4, wherein the bottom portion comprises two bottom walls arranged at an angle relative to each other; a mounting groove is formed between the two bottom walls, the two bottom walls gradually approaching each other in a direction towards the top portion; the flexible squeegeeing element comprises two second surfaces opposite to the two first surfaces respectively, the two second surfaces being respectively supported on the two bottom walls, so that the flexible squeegeeing element is obliquely arranged on the mounting element.

9. The screen protector applicator according to claim 1, wherein the support assembly comprises a base and a placement seat movably connected to the base; the placement seat is configured to place the mobile terminal and the screen protector assembly; and the squeegeeing assembly is connected to the base and movable together with the base relative to the placement seat.

10. The screen protector applicator according to claim 9, wherein
the screen protector assembly comprises a protective film and a release film attached to the protective film; and
the base is provided with a film-peeling structure configured to peel off a release film of the screen protector assembly, such that when the placement seat slides relative to the base, the release film can be peeled off by the film-peeling structure.

11. The screen protector applicator according to claim 10, wherein
a side of the base facing away from the squeegeeing assembly is provided with a stop arm configured to abut against a pull tab of the release film of the screen protector assembly;
a sliding space is provided at a bottom side of the stop arm, and the placement seat has a first mounting structure slidably positioned in the sliding space; the first mounting structure is configured to mount the pull tab; and
the placement seat is provided with a mobile terminal placement groove, and a positioning structure is provided beside the mobile terminal placement groove and is configured to position the screen protector assembly.

12. The screen protector applicator according to claim 11, wherein
the screen protector assembly further comprises a pull tab arranged on a side of the release film facing away from the protective film, one end of the pull tab being connected to one end of the release film, another end of the pull tab extending beyond another end of the release film, and said another end of the pull tab being provided with a second mounting structure corresponding to the first mounting structure.

13. The screen protector applicator according to claim 12, wherein
when the placement seat is slid to a position where a squeegeeing structure press-contacts the screen protector assembly, a distance between a peeling position where the release film begins to be peeled off from the protective film and the squeegeeing structure of the squeegeeing assembly is greater than or equal to 0.1 mm and less than or equal to 0.8 mm; and
the first mounting structure is a locking block, the second mounting structure is a locking opening, the pull tab comprises an extension segment between said one end of the pull tab and said another end of the pull tab, and a thickness of said another end of the pull tab is greater than a thickness of the extension segment.

14. The screen protector applicator according to claim 16, wherein the first mounting structure is located on a side of the stop arm facing away from the squeegeeing assembly.

15. The screen protector applicator according to claim 1, wherein the squeegeeing assembly further comprises a mounting element, and the flexible squeegeeing element is arranged at a bottom portion of the mounting element; the mounting element is removably arranged on the support assembly; the support assembly is provided with a slide groove and a through groove communicated with the slide groove; the mounting element is configured to slide along the slide groove relative to the support assembly; the through groove is configured to allow the mounting element to be detached from the support assembly therethrough or to enter the slide groove via the through groove.

16. The screen protector applicator according to claim 15, further comprising a cover rotatably connected to the support assembly; the cover is provided with a first locking structure, and the mounting element is provided with a second locking structure configured to be engaged with the first locking structure, so that rotation of the cover can bring the mounting element to be detached from the support assembly through the through groove; and
the cover is provided with a first guide structure, and the mounting element is provided with a second guide structure configured to cooperate with the first guide structure to guide the mounting element to be mounted onto the cover.

17. The screen protector applicator according to claim 1, wherein the squeegeeing assembly further comprises a mounting element, and the flexible squeegeeing element is arranged at a bottom portion of the mounting element; the mounting element is rotatably arranged on the support assembly; the support assembly is provided with a mobile terminal placement area, the mounting element is configured to be rotate between a first position and a second position, wherein in the first position, the mounting element covers part of the mobile terminal placement area; and in the second position, the mounting element is located outside the mobile terminal placement area.

18. The screen protector applicator according to claim 17, wherein the support assembly is provided with a slide rail; the slide rail comprises a first extension section, a bent section, and a second extension section; the first extension section extends along a length direction of the support assembly; one end of the bent section is connected to the first extension section, another end of the bent section bends towards a bottom side of the support assembly; the second extension section is connected to said another end of the bent section and extends towards the first extension section; the bent section is configured to prevent the mounting element from being detached from the support assembly during rotation of the mounting element relative to the support assembly;
the mounting element comprises a first pivot shaft and a rotation limiting part, the first pivot shaft is configured to slide along the first extension section, the rotation limiting part is spaced apart from the first pivot shaft and configured to prevent the mounting element from rotating during sliding of the mounting element relative to the support assembly; the support assembly is further provided with a notch configured to allow the rotation limiting part to exit from the first extension section through the notch so that the mounting element is capable of rotating to the second position relative to the support assembly; and
the support assembly comprises a second pivot shaft; and the first pivot shaft is provided with an engaging groove configured to engage with the second pivot shaft, so as to prevent the mounting element from sliding during rotation of the mounting element relative to the support assembly.

19. The screen protector applicator according to claim 1, wherein the flexible squeegeeing element comprises a first flexible squeegeeing part and a second flexible squeegeeing part; the first squeegeeing part has a pressure-applying flat surface configured to apply a pressure on a flat portion of a curved screen; the second flexible squeegeeing element is spaced apart from the first flexible squeegeeing element and two opposite ends of a bottom portion of the second flexible squeegeeing element are respectively provided with two pressure-applying protrusions configured to apply a pressure on a curved portion of the curved screen.

20. The screen protector applicator according to claim 19, wherein
a width of the second flexible squeegeeing element is greater than that of the first flexible squeegeeing element; and
the second flexible squeegeeing element comprises a connection portion connected between the two pressure-applying protrusions; a height of the connection portion is smaller than that of the pressure-applying flat surface so that the connection portion is farther from the screen protector assembly than the pressure-applying flat surface when the squeegeeing assembly applies the pressure onto the screen protector assembly.
